(19) United States
(12) Patent Application Publication
(10) Pub. No.: US 2010/0201141 A1
(43) Pub. Date: Aug. 12, 2010

(54) LASSO HANDLING DEVICE

(76) Inventor: WALTER PETER WRIGHT, Gold Coast (AU)

Correspondence Address: Walter Peter Wright, 103 Gibraltar Drive, Isle of Capri, Gold Coast, 4217, omitted

(21) Appl. No.: 12/679,908

(22) PCT Filed: Sep. 25, 2008
(86) PCT No.: PCT/AU08/01427

§ 371 Date: Mar. 25, 2010

(30) Foreign Application Priority Data
Sep. 28, 2007 (AU) 2007905326

(51) Int. Cl. B63B 21/04; F16G 11/12; A01K 15/04

(52) U.S. Cl. 294/19.1; 24/115 R; 24/115 K

(57) ABSTRACT

A lasso handling device (9) for handling lassos of the type comprising an elongated rope (27) having a looped end (28) and a free end, the lasso handling device (9) including an elongated pole (10) having a first rope gripping member (13) at one end for gripping a first enlarged portion of the rope (27) and a second rope gripping member (24) for gripping a second portion of the rope (27) to hold the looped end (28) open to facilitate its location about an object or animal to be lassoed. The rope (27) is releasable from the gripping members (13) and (24) to allow tightening of the lasso around the object or article.

### TECHNICAL FIELD

This invention relates to a lasso or lariat handling device and in particular a lasso handling device for holding and supporting a lasso for facilitating the capture of animals such as cattle and the capture of objects such as dock cleats for facilitating the connection of a boat mooring line to a mooring point. The present invention also relates to a rapid release mechanism for fast and accurate release of the lasso from the lasso handling device.

### BACKGROUND ART

Capture of animals and objects are often performed by the use of a lasso or lariat. The lasso or lariat comprises a rope with an eyelet at one end and the free end of the rope passes through the eyelet to form a loop. The lasso loop is free to contract in diameter once placed over the animal or object thus facilitating capture.

There are devices for holding the lasso or lariat when placing the loop of the lasso or lariat over an animal or object to facilitate the capture of the animal or object. These devices used are slow in operation and inaccurate and when used for the capture of animals, failure can result in agitation of the animal resulting in difficulty of further capture.

Lassoing is also used for purpose of capture of an object such as a dock cleat when mooring a boat where it is important that the boat is moored on the first attempt. Failure to capture the mooring point at the first attempt can result in damage to the boat and/or injury to the personnel attempting the mooring.

Some devices have been proposed with the aim of overcoming the above disadvantages However in general these devices have not been particularly effective.

### SUMMARY OF THE INVENTION

The present invention aims to provide a lasso handling device which overcomes or alleviates the above disadvantages or which at least provides an alternative to the known lasso handling devices. Other objects and advantages of the invention will become apparent from the following description.

The present invention thus provides in one preferred aspect, a lasso handling device for handling lassos of the type comprising an elongated rope having a looped end and a free end, said lasso handling device having first holding means for releasably holding a first portion of said rope within said looped end and second holding means spaced from said first holding means for releasable holding a second portion of said rope within said looped end to hold said looped end open for location over an animal or object.

The term “rope” as used throughout the specification and claims includes any form of flexible line or rope and typically may comprise a multi-stranded rope such as a synthetic or natural rope having three or more strands or a braided rope.

Preferably the respective holding means are configured such that the force required to release the rope from the first holding means is greater than the force required to release the rope from the second holding means. Preferably the holding means comprise resilient holding or gripping means and the resilient force applied in use by the first holding means is greater than the resilient force applied in use by the second holding means.

Preferably the rope has an eyelet at one end and the lasso is defined by passing or threading a free or other end of the rope through the eyelet to form the looped end. The eyelet may be formed by splicing the rope.

The rope may have an enlarged diameter portion within the looped end adapted to be gripped by the first holding means. The enlarged diameter portion may comprise an enlarged portion at the one end whereby the diameter of the rope is increased by the splicing of the rope to form the eyelet and/or the diameter of the rope may be increased at a selected point by circumscribing the rope at that point by a diameter build up material such as tape or Velcro to form an enlarged portion of the rope. The selected point on the rope at which the buildup material is placed can establish the size of the loop of the lasso defined by the looped end of the rope.

The lasso handling device may be combined with or incorporated in an elongated tubular pole of wood, metal or other material having a free end and a handle end. The tubular pole can be of the extendable type. A rope gripping means comprising the first means for releasably holding a first portion of the rope may be located adjacent to the free end of the tubular pole. The rope gripping means may comprise a channel shaped clamping member adapted to resiliently grip the rope and suitably the enlarged portion of the rope. The channel shaped clamping member may be detachably secured to the pole. Preferably the channel shaped clamping member is screw engaged with the pole. The channel shaped clamping member may extend longitudinally of the pole and may further be angled to the pole to diverge outwardly there from rearward from the end of the pole.

Preferably co operable coupling means are provided between the pole and the channel shaped member. The co operable coupling means allow for resistance of lateral movement of the channel shaped member relative to the pole

The second releasable holding means is suitably spaced from the first releasable holding means longitudinally along the pole. The spacing of the second holding means from the first holding means may be selectively adjustable. Suitably the second holding means is slidable longitudinally of the pole to adjust the spacing from the first holding means. Preferably the second holding means when holding the second portion of the rope is locked or braked against substantial sliding movement along the pole.

The second holding means may comprise an elongated arm or member adapted to resiliently clamp the rope against the pole. The arm or member may comprise a resilient hook which extends longitudinally of and substantially parallel to the pole and is spaced outwardly therefrom.

The elongated arm or member is suitably connected to and extends from an adjustable sliding sleeve member. The adjustable sliding sleeve member is located coaxially relative to and circumscribes the pole and is positioned between the channel shaped clamping member and the handle end of the pole and can thus be moved longitudinally along the tubular pole for adjustment of the required size of the loop of the lasso. The resilient hook and the connected adjustable sliding sleeve can be made of either plastic or metal.

The elongated arm or member is positioned on the tubular pole to face in an inward direction towards the channel shaped clamping member and defines an open mouth with the pole facing towards the channel shaped clamping member for receiving the rope and form a rapid release mechanism allowing a rapid release of the rope and lasso from the lasso handling device. Suitably the arm or member includes an indent to locate the rope. The arm or member may also include an enlarged jaw at its leading end extending towards the pole and forming the arm or member into a hook, the jaw restricting the entrance of the mouth to ensure that the rope when inserted into the mouth and past the jaw can be captured effectively between the member and pole. The resilient force applied by the arm or member may be due to resilience in the member or by a resilient connection of the arm or member to the sleeve member.

Preferably, when the rope has an eye formed by a splice defining the enlarged portion, the enlarged portion in use is held and supported by the channel shaped clamping member with the eyelet positioned in a rearward direction from the clamping member towards the handle end of the pole.

The rope of the lasso that passes outwards to the front of the channel shaped clamping member forms is passed through the eye to form a loop of the selected lasso size and the rope within the loop is held transversely to the tubular pole by the resilient hook.

The rope when held by the resilient hook transversely against the side of the tubular pole functions as a brake and locks the adjustable sleeve member against the tubular pole preventing the adjustable sleeve member moving longitudinally along the tubular pole. The braking function ceases when the rope of the lasso is released from the jaw of hook.

The rope is reeved into the hook in a manner to facilitate the rapid release of the lasso once the animal or object is caught.

The rope is transversely held by the hook and from the held position by the hook, the free end of the rope passes through the eyelet opposite the side of the hook that supports the loop of the lasso. As the free end of the rope extends through the eyelet, the eyelet is thus supported adjacent to the hook. The free end of the rope then extends in use towards the handle end of the pole where it is held by the operator.

A rapid release is facilitated by the contraction of the lasso around the captured animal or captured object and with the free end of the rope held firmly by the operator the rope pivots against the eyelet of the lasso causing a force that rapidly ejects the rope from between the hook and pole.

The lasso rope diameter contracts around the captured animal or object and the lasso rope continues to be held by the channel shaped clamping member which has a rope holding force greater than that of the hook.

Thus the channel shaped clamping member of the device may now be adapted to direct the loop defining portion of the lasso whereby the contracting loop may be manipulated to accurately locate around an animal or object

When the defining portion of the lasso loop is accurately located around the caught animal or object. the operator sharply pulls the pole back and the lasso is released from the channel shaped clamping member when the rope portion of the lasso passes from the large spliced or taped diameter of the rope to a smaller diameter where it thus cannot be held and the lasso is then released around the caught animal or object.

Many applications can be performed by this invention such as applications for marine rescue, construction rigging and boat mooring.

### BRIEF DESCRIPTION OF THE DRAWINGS

In order that the invention may be more readily understood and put into practical effect, reference will now be made to the accompanying drawings which illustrate a preferred embodiment of the invention and wherein:

FIG. 1 is an isometric view of a lasso handling device according to an embodiment of the present invention holding a lasso;

FIG. 2 is an isometric view of the lasso handling device without an attached lasso;

FIG. 3 is an isometric view of the channel shaped clamping member;

FIG. 4 is an isometric view of the hook of the lasso handling device attached to an adjustable sleeve member;

FIGS. 5, 6 and 7 illustrate the hook attached to an adjustable sleeve member in side, end and top view;

FIG. 8 illustrates the resilient hook in side view holding the rope of the lasso showing also the braking action instigated by the rope when held between the hook and the tubular pole of the device;

FIGS. 9, 10, 11 and 12 Illustrate the channel shaped clamping member, in side, end, top and underside view;

FIG. 13 illustrates the lasso handling device in side view holding the lasso;

FIG. 14 illustrates the lasso handling device in top view holding the lasso;

FIG. 15 Illustrates the lasso handling device in side view holding the lasso located over an object and showing also the release of the rope from the hook;

FIG. 16 illustrates the lasso handling device in top view holding the lasso located over an object and demonstrating the release of the rope from the hook;

FIG. 17 illustrates the lasso handling device in side view demonstrating the release of the lasso from the channel shaped clamping member;

FIG. 18 Illustrates the lasso handling device with the hook attached to the adjustable sleeve, adjusted to a position on the tubular pole for handling small lasso's;

FIG. 19 Illustrates the lasso handling device with the hook adjusted in a position on the tubular pole holding a large lasso with a loop adjusted to an enlarged opening; and

FIG. 20 Illustrates the channel shaped clamping member in side view and also showing a rope circumscribed by material such as tape or Velcro that increases the diameter of the rope to a diameter that can be held and supported by the channel shaped clamping member.

### DETAILED DESCRIPTION OF THE PREFERRED EMBODIMENT

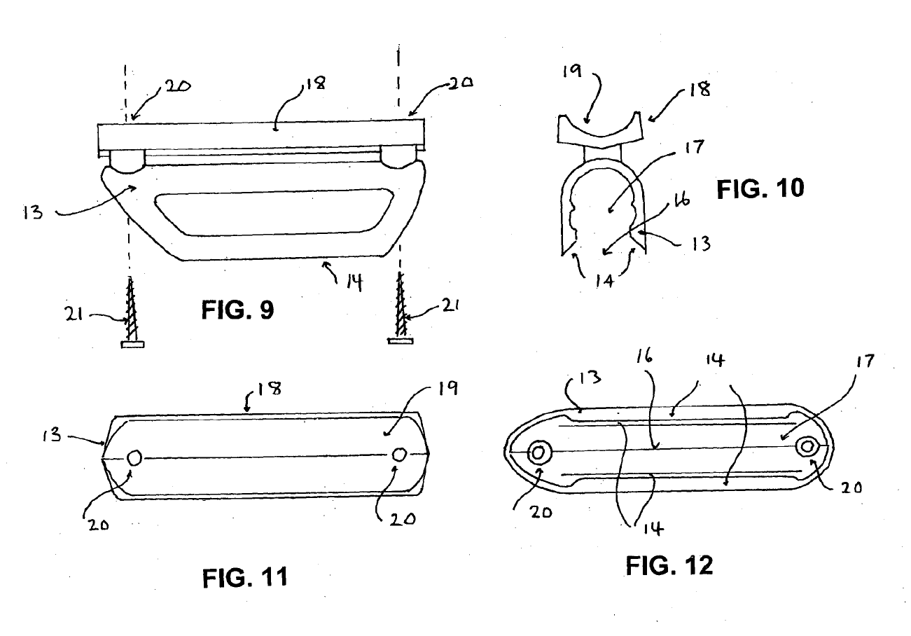

Referring to the drawings and firstly to Fig,1 there is illustrated a lasso handling device 9 according to the present invention which typically comprises a device 9 adapted to handle lasso's of variable loop size with speed and accuracy, the device 9 including a tubular extended pole 10 which can be adjustable in length. The pole 10 has a free end 11 and a handle end 12. Mounted on the tubular pole 10 adjacent to the free end 11 is a channel shaped clamping member or line gripper 13. The clamping member 13 as shown more clearly in FIG. 3 and FIGS. 9 to 12 is resilient and comprises an elongated channel shaped member of part circular form in cross section and having a pair of opposite curved side flanges or jaws 14. Inwardly directed teeth like ribs 15 are provided adjacent the free longitudinal edges of the flanges or jaws 14 and define a restricted entrance 16 into the interior 17 of the channel shaped member 13. The leading end of the channel shaped member 13 is tapered.

The channel shaped member 13 is provided with a mounting flange 18 on its topside, that is the side opposite the flanges or jaws 14 with the mounting flange 18 extending longitudinally of the channel shaped clamping member 13 and the mounting flange 18 and includes on one side a shallow recess 19 complimentary to the tube shape of the pole 10. Spaced apertures 20 are provided in the mounting flange 18 and extend through to the “channel” side of the member 13 to accept screws 21 which may be driven into apertures in the tubular pole 10 to hold the flange 18 to the tubular pole 10.

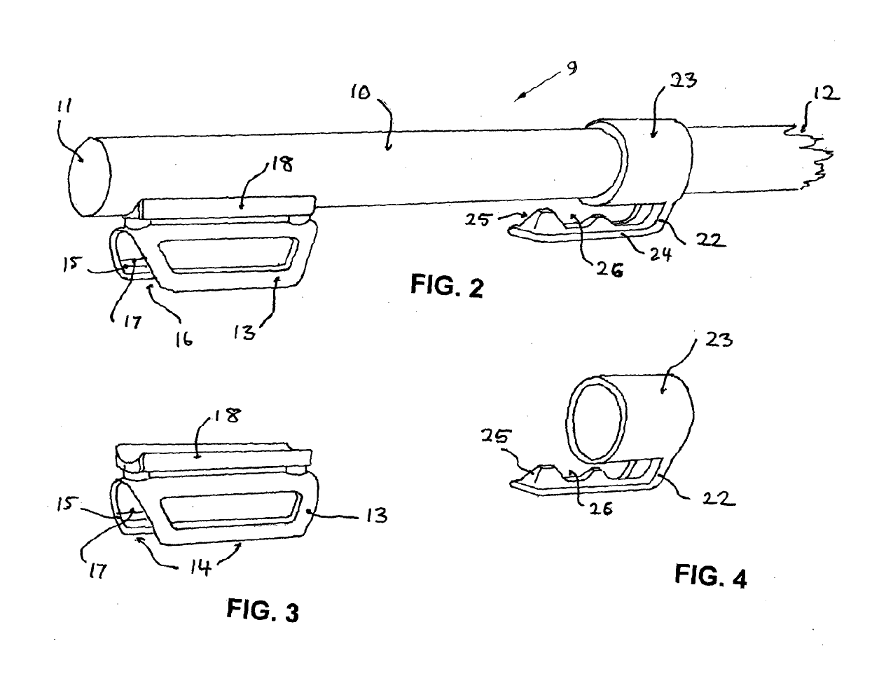

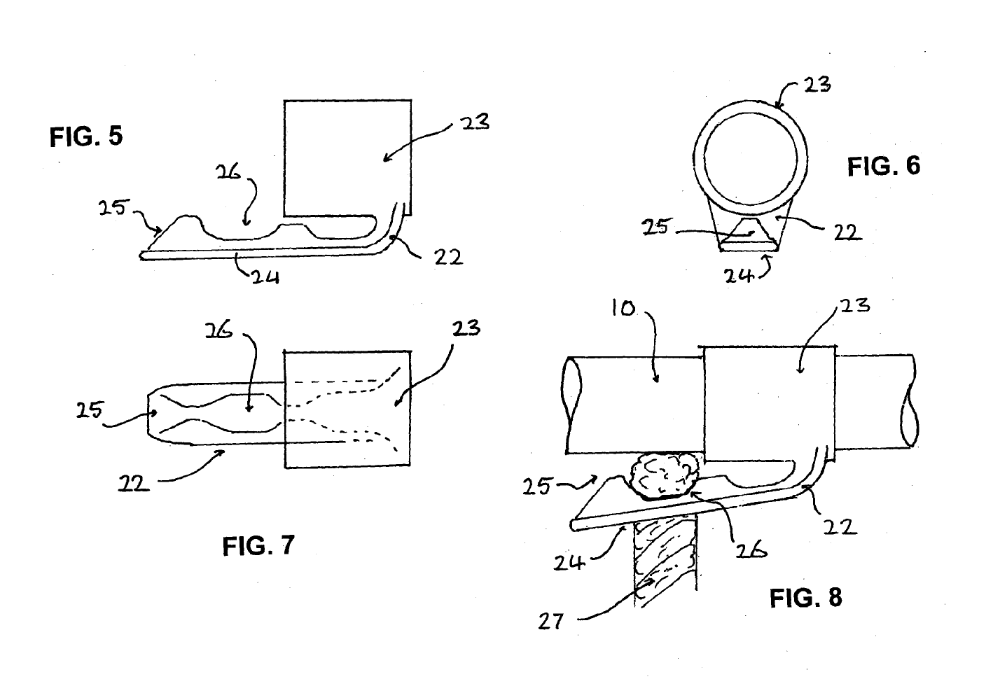

A resilient hook 22 is connected to an adjustable sliding sleeve 23 as shown in FIGS. 2 and 4 to 8 which circumscribes the tubular pole 10 between the channel shaped member 13 and the handle end 12, the hook 22 being defined by an elongated member or arm 24 extending from the sleeve 23 and longitudinally of the pole 10 and terminating in an enlarged jaw 25 which extends towards the pole 10 and which defines with the pole 10 a restricted mouth for capturing the rope of the lasso as described below. The resilient hook 22 is shaped to accept ropes of various sizes in an indent section 26 formed in the member 24. The resilience of the hook 22 is achieved by the length of the arm or member 24 and the resilient hook 22 can be constructed of any resilient material such as plastic or metal. The adjustable sliding sleeve 23 can be constructed of material such as plastic or metal. The resilient hook 22 and the adjustable sleeve 23 are attached and may be formed as a single component such as by an integral moulding or formed as separate joined components.

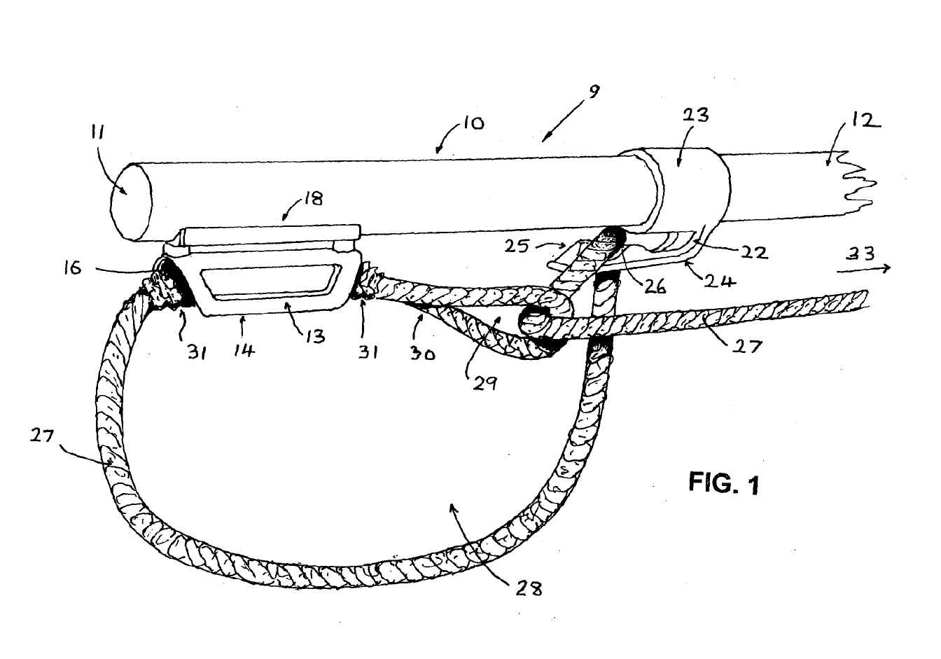

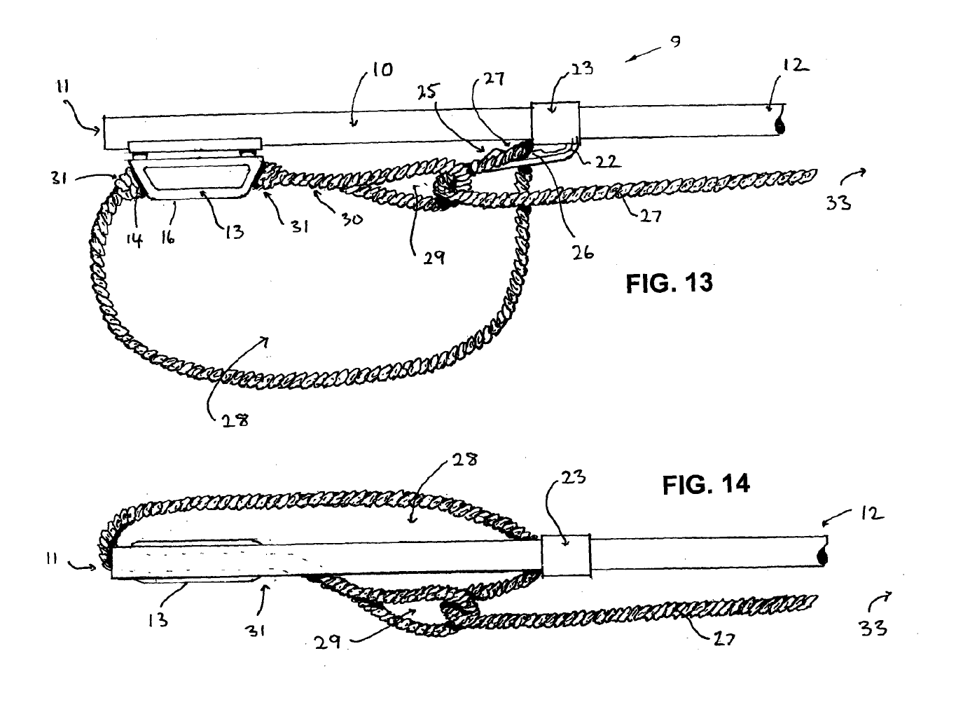

The lasso handling device 9 is particularly suited to handling a rope 27 which has a loop 28 to define a lasso, the rope 27 being of the type having an eyelet 29 at one end defined by an end portion 30 of the rope 27 which is looped back on itself and secured such as by means of a splice 31 to a further portion of the rope 27 as shown in FIGS. 13,14,15,16 and 17. The splice 31 which constitutes a transversely enlarged portion of the rope 27 can be engaged with the channel shaped member 13 by being pressed into the entrance 16 in the member 13 to cause the flanges or jaws 14 to be resiliently deflected and to be received in the interior 17 of the member 13 with the splice 31 being gripped resiliently by the flanges or jaws 14. In the embodiment illustrated in FIGS. 1, 13 and 14 the splice 31 is positioned to be resiliently gripped by the channel shaped clamping member 13 such that the eyelet 29 is positioned rearwardly of the channel shaped clamping member 13.

This configuration allows the free end of the rope 27 to be held by the resilient hook 22 transversely to the tubular pole 10. For this purpose, the rope 27 is pushed past the jaw 25 of the resilient hook 22 and is held transversely in the indent section 26 formed in the arm 24 of the resilient hook 22. The rope 27 is held by the arm or member 24 against the tubular pole 10 as shown in FIG. 8 to form a braking action to prevent the adjustable sliding sleeve 23 moving longitudinally along the tubular pole 10 until the rope 27 is released from the jaw 22.

The free end of the rope 27 passes across the indent section 26 of the resilient hook 22 and through the eyelet 29 to form the loop 28. The free end of the rope 27 passes back to the handle end 12 of the tubular pole 10 and is held by the operator 33.

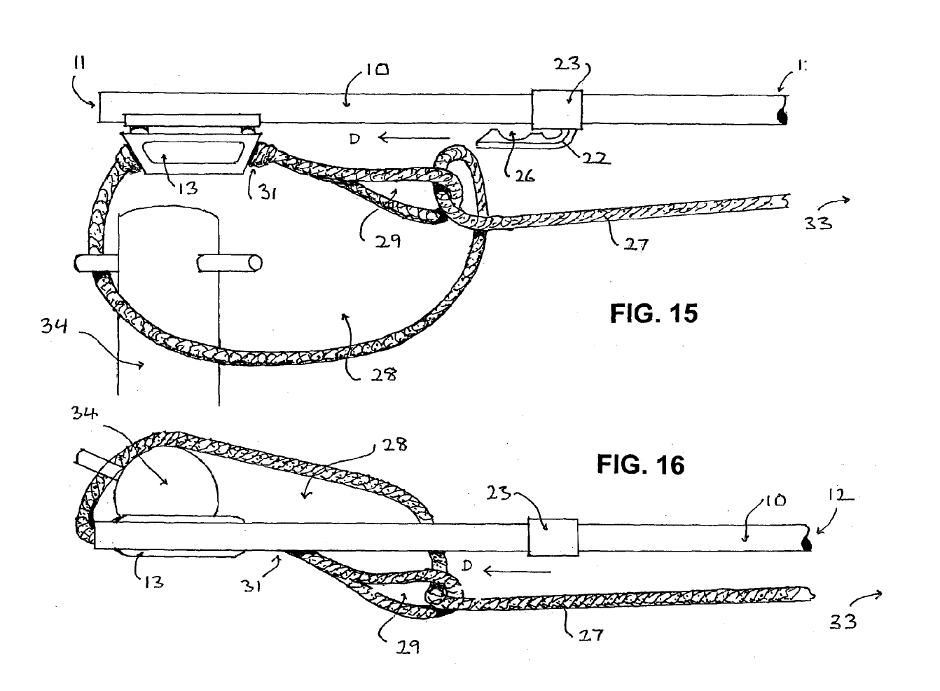

The fast release of the rope 27 from the resilient hook 22 is facilitated by the contraction of the lasso loop 28 around the caught object 34 as shown in FIGS. 15 and 16. The free end of the rope 27 held firmly by the operator 33 effectively causes the rope 27 to pivot around the fixed point of the eyelet 29 creating a force exceeding the force required by the resilient hook 22 to hold the rope 27 and the rope is thus forcibly ejected from the resilient hook 22 in the direction D.

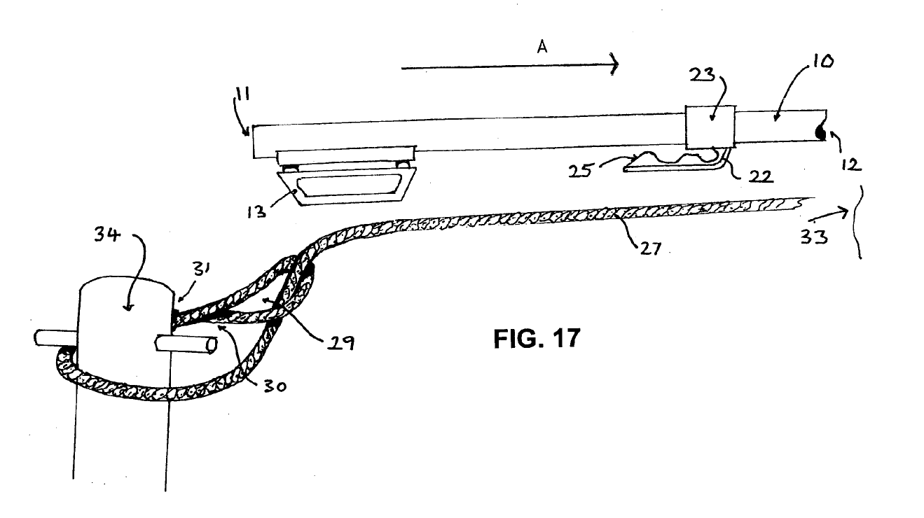

Release of the rope 27 with the splice 31 from the channel shaped clamp 13 is affected by the operator 33 sharply pulling the tubular pole 10 back in the direction A as Illustrated in FIG. 17. The channel shaped clamp moves from the large diameter splice 31 to the smaller diameter of the rope 27 which cannot be held leaving the released lasso loop 28 around the caught animal or object 34.

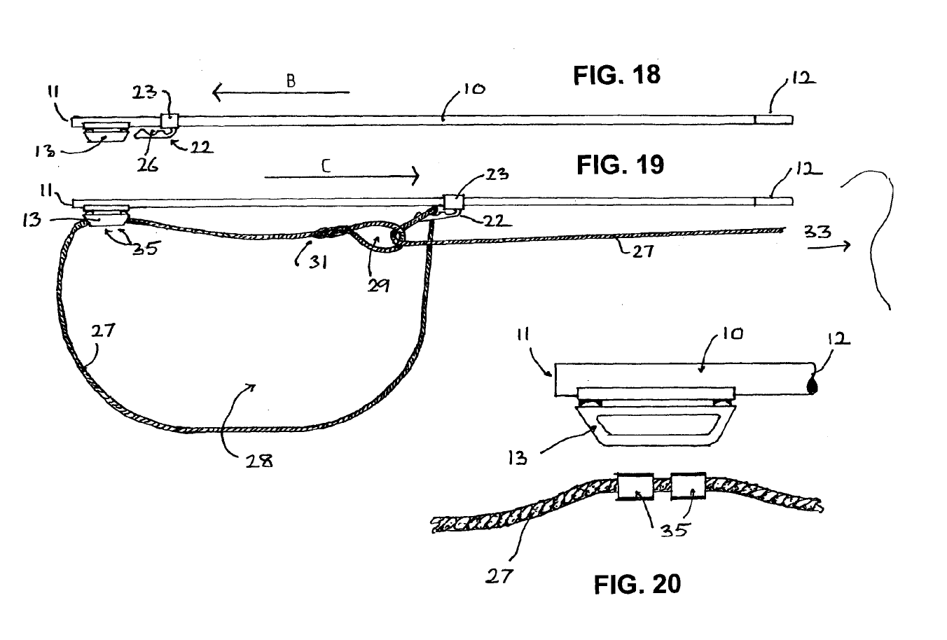

Referring to FIGS. 18 and 19 the lasso size can be adjusted by the movement of the adjustable sleeve 23 in direction B along the pole 10 to lessen the lasso size as illustrated in FIG. 18 and in direction C to increase the lassos size as illustrated in FIG. 19.

FIG. 19 illustrates an enlarged lasso loop 28 held and supported by the channel shaped clamping member 13 and the resilient hook 22. The rope 27 held by the channel shaped clamping member 13 has an increased diameter, increased by diameter build up material such as tape or Velcro 35 as illustrated in FIG. 20. Release of the rope 27 is similar to that as described above with reference to FIG. 17 within in this case release of the diameter build material 35 from the channel shaped clamping member 13 being affected by the operator 33 pulling the tubular pole 10 back in the direction A. The channel shaped clamping member 13 moves from the large diameter 35 to the smaller diameter of the rope 27 and cannot be held leaving the released lasso loop 28 around the caught animal or object 34.

It will be appreciated that the channel shaped clamping member 13 and the resilient hook 22 may be varied in size to suit various sized lasso ropes 27 with which the lasso handing device 9 is to be used. Furthermore, the clamping member 13 and hook 22 may be of various different configurations and designs. Whilst the resilience of the resilient hook 22 may be due to the inherent resilient in the arm 24 of the hook 22, the arm 24 alternatively may be relatively rigid and joined to the sleeve member 23 through a resilient connection, for example via a spring loaded pivot or through are resilient plastics connection.

The use of the term “comprising” or derivatives thereof as used throughout the specification and claims are taken to specify the presence of the stated features, integers and components referred to but not preclude the presence or addition of one or more other feature/s, integer/s, component/s or group thereof.

Whilst the above has been given by way of illustrative embodiment of the invention, all such variations and modifications thereto as would be apparent to persons skilled in the art are deemed to fall within the broad scope and ambit of the invention as defined in the appended claims.

1. A lasso handling device for handling lassos of the type comprising an elongated rope having a looped end and a free end, said lasso handling device having first holding means for releasably holding a first portion of said rope within said looped end and second holding means spaced from said first holding means for releasable holding a second portion of said rope within said looped end to hold said looped end open for location over an animal or object.

2. A lasso handling device as claimed in claim 1 wherein said holding means are configured such that the force required to release the rope from the first holding means is greater than the force required to release the rope from the second holding means.

3. A lasso handling device as claimed in claim 1 or claim 2 wherein said rope has an eyelet at one end and wherein the lasso is defined by passing or threading a free or other end of the rope through the eyelet to form the looped end.

4. A lasso handling device as claimed in claim 3 wherein said rope has an enlarged diameter portion within said looped end adapted to be gripped by said first holding means.

5. A lasso handling device as claimed in any one of claims 1 to 4 combined with or incorporated in an elongated pole, said pole having a free end and a handle end and wherein said first holding means is located adjacent said free end.

6. A lasso handling device as claimed in claim 5 wherein said holding means comprise resilient holding or gripping means and the resilient force applied in use by the first holding means is greater than the resilient force applied in use by the second holding means.

7. A lasso handling device as claimed in claim 6 wherein said first holding means comprises a rope gripping means having a channel shaped clamping member and adapted to resiliently grip the rope.

8. A lasso handling device as claimed in any one of claims 5 to 7 wherein said second releasable holding means is slidable longitudinally of the pole to adjust its spacing from the first holding means.

9. A lasso handling device as claimed in claim 8 wherein said second holding means when holding the second portion of the rope is locked or braked against substantial sliding movement along the pole.

10. A lasso handling device as claimed in claim 9 wherein said second holding means comprises an elongated arm or member adapted to resiliently clamp the rope against the pole.

11. A lasso handling device as claimed in claim 10 wherein said arm or member is connected to and extends from a sleeve member which is located coaxially relative to the pole and is slidable therealong.

12. A lasso handling device as claimed in claim 11 wherein said arm or member extends towards the channel shaped clamping member and defines an open mouth with the pole facing towards the channel shaped member adapted to receive the rope.

13. A lasso handling device as claimed in claim 12 wherein said arm or member includes a jaw at its free end extending towards said pole.

14. A lasso handling device as claimed in claim 13 wherein said arm includes an indent for locating said rope.
